(19) United States
(12) Patent Application Publication
(10) Pub. No.: US 2008/0001946 A1
(43) Pub. Date: Jan. 3, 2008

(54) Apparatus for and method of displaying image

(75) Inventor: Akio Ishikawa, Fujinomiya-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Minato-ku (JP)

(21) Appl. No.: 11/808,831

(22) Filed: Jun. 13, 2007

(30) Foreign Application Priority Data
Jun. 20, 2006 (JP) 2006-169841

(51) Int. Cl. G06T 17/00

(52) U.S. Cl. 345/420

(57) ABSTRACT

A plurality of viewers which correspond to a plurality of different image file formats, respectively, are activated. An image file retrieving means retrieves a desired image file according a retrieval condition entered by a retrieval condition inputting means. An extension confirming means confirms an image file format of the retrieved image file. A viewer selecting means selects a viewer corresponding to the retrieved image file format to display the image data of the retrieved image file.

### BACKGROUND OF THE INVENTION

1. Field of the Invention

The present invention relates to an apparatus for and a method of displaying images using viewers compatible with the image file formats of the images.

1. Description of the Related Art

There has heretofore been developed an image display apparatus for storing image data obtained by reading a number of design drawings, specifications, or the like with a scanner, or CAD drawing data generated with a CAD apparatus (computer-assisted design apparatus), as digital data in a large-capacity recording medium such as a hard disk, a CD-ROM, a DVD, or the like, specifying retrieval conditions when necessary, to retrieve a desired image file, and displaying the image data of the retrieved image file on a display unit using a viewer compatible with the image data.

The image file format of image data differs from program to program for generating image data. There is no viewer available for display image data of all image data formats that exist. Therefore, it is the general practice to convert a plurality of image data of different image file formats into image data of an image file format that is compatible with the viewer and to display the converted image data with the viewer (see Japanese Laid-Open Patent Publication No. 9-245035).

According to the above process, however, each time image data of a different image file format is to be displayed, the image data has to be converted. If a number of image data of different image file formats need to be switched and displayed successively, then the image data converting process takes so much time that the image data cannot be displayed at a high rate.

### SUMMARY OF THE INVENTION

It is a general object of the present invention to provide an apparatus for and a method of displaying a plurality of images of different image file formats at a high rate.

A major object of the present invention is to provide an apparatus for and a method of displaying a plurality of images of different image file formats successively without concern over switching viewers.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a block diagram of a drawing management system according to an embodiment of the present invention;

FIG. 2 is a functional block diagram of a drawing retrieving unit of the drawing management system according to the embodiment;

FIG. 3 is a flowchart of a processing sequence of the drawing management system according to the embodiment;

FIG. 4 is a view showing a retrieval condition input image displayed on the display monitor of the drawing retrieving unit;

FIG. 5 is a view showing an individual drawing browsing image displayed on the display monitor of the drawing retrieving unit; and

FIG. 6 is a diagram showing a viewer switching process performed by the drawing retrieving unit.

### DESCRIPTION OF THE PREFERRED EMBODIMENT

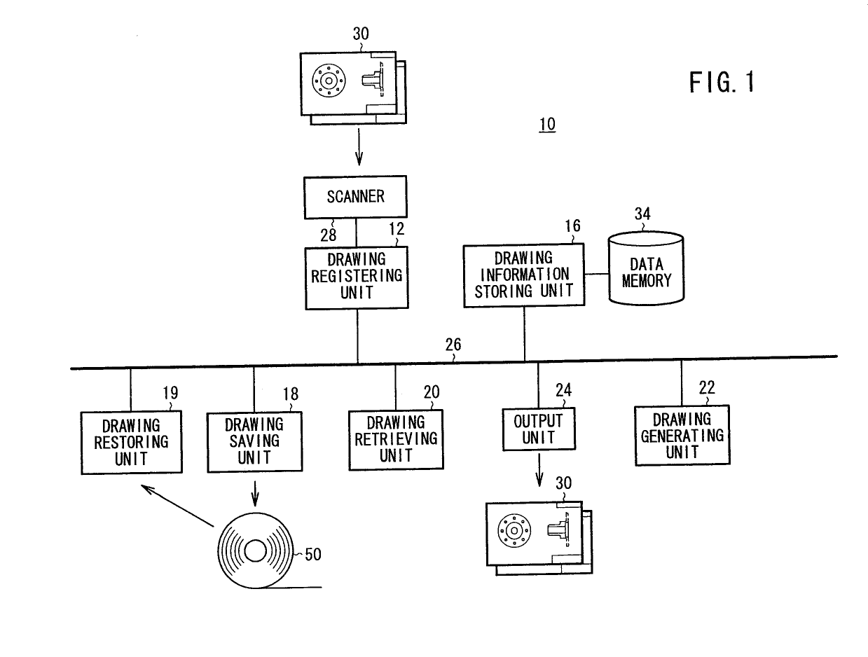

FIG. 1 shows in block form a drawing management system which utilizes an apparatus for and a method of displaying images according to the present invention.

As shown in FIG. 1, the drawing management system 10 comprises a drawing registering unit 12, a drawing information storing unit 16, a drawing saving unit 18, a drawing restoring unit 19, a drawing retrieving unit 20, a drawing generating unit 22, and an output unit 24 which are all connected to each other by a network 26.

The drawing registering unit 12 reads a paper drawing 30 with a scanner 28 connected thereto to acquire image data, and registers attribute data representing an ID number and a drawing title specifying the paper drawing 30, department information about a department and a line related to the paper drawings 30, a date on which the paper drawing 30 is generated, and a person in charge of the paper drawing 30.

The drawing 30 includes not only a drawing of a machine, a facility, a circuit, or the like, but also a document image of every type of paper document such as an inspection document, a calculation document, an estimation document, or the like about a facility construction.

The drawing generating unit 22 comprises a CAD (Computer-Aided Design) device for generating design drawings. As with the drawing registering unit 12, the drawing generating unit 22 can register attribute data about generated design drawings.

The drawing information storing unit 16 stores image data and attribute data registered by the drawing registering unit 12, and image data and attribute data about the design drawings generated by the drawing generating unit 22, as image files in a data memory 34 that is connected to the drawing information storing unit 16. The image data generated by the drawing registering unit 12 and the drawing generating unit 22 have various image file formats including TIFF (Tagged-Image File Format), GIF (Compuserve Graphic Interchange Format), JPEG (Joint Photographic Experts Group), PDF (Portable Document Format), etc. depending on the application used to generate and process the image data. The data memory 34 stores image data of different image file formats.

The drawing saving unit 18 saves image data stored in the data memory 34 directly in its image format in a microfilm 50 through a CD-ROM or the like, and also saves attribute data related to the image data in a visualized code format that can be restored.

The drawing restoring unit 19 reads information recorded in the microfilm 50 and restores attribute data and image data from the read information.

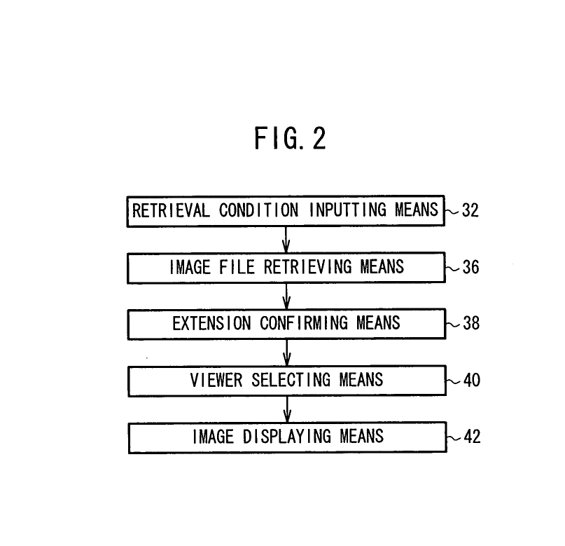

The drawing retrieving unit 20 is a device for retrieving a desired image file from the image files stored in the data memory 34, displaying the retrieved image file, and, when necessary, outputting the image file to a paper medium or the like from the output unit 24. As shown in FIG. 2, the drawing retrieving unit 20 comprises a retrieval condition inputting means 32 for entering a retrieval condition according to attribute data, an image file retrieving means 36 for retrieving a desired image file using the retrieval condition, an extension confirming means 38 (confirming means) for confirming the extension of the retrieved image file, a viewer selecting means 40 (selecting means) for selecting a viewer which is capable of processing the image file accompanied by the selected extension, and an image displaying means 42 (displaying means) for displaying image data using the selected viewer on a display screen.

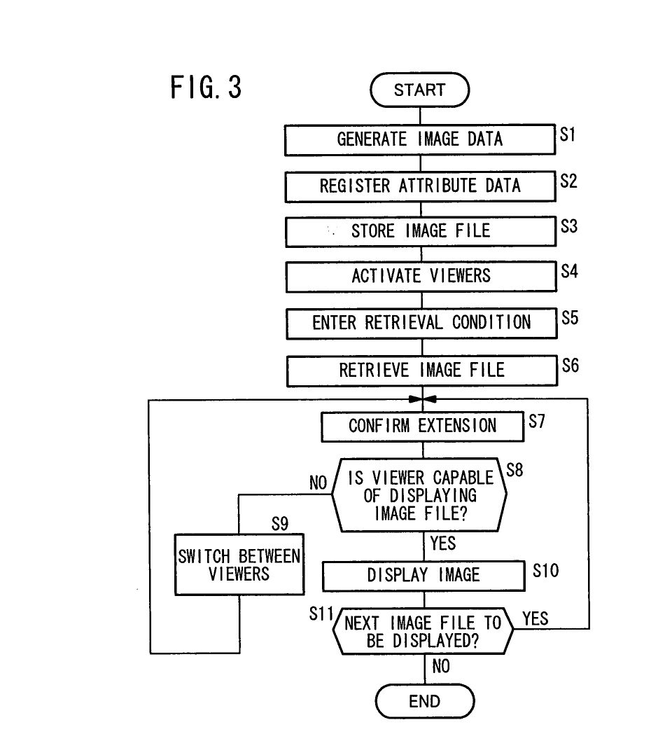

The drawing management system 10 according to the present embodiment is basically constructed as described above. A processing sequence of the drawing management system 10 will be described below with reference to a flowchart shown in FIG. 3.

First, image data is generated using the drawing registering unit 12 or the drawing generating unit 22 in step S1. If image data is generated using the drawing registering unit 12, then a design drawing or a document drawing provided as the paper drawing 30 is read by the scanner 28. If image data is generated using the drawing generating unit 22, then image data as a design drawing is generated using CAD software (computer-assisted design software).

Then, attribute data representing an ID number and a drawing title of the generated image data, department information about a department and a line related to the image data, a date on which the image data is generated, and a person in charge of the image data, are registered from the drawing registering unit 12 or the drawing generating unit 22 in step S2. The image data and the attribute data are stored as an image file in the data memory 34 of the drawing information storing unit 16 in step S3. The format of the image file stored in the data memory 34 is any of various image file formats depending on the device used to generate the image data.

The image data and the attribute data that have been generated using the drawing registering unit 12 or the drawing generating unit 22 are also saved in the microfilm 50 by the drawing saving unit 18 for backup purpose. When necessary, the image data and the attribute data saved in the microfilm 50 can be restored by the drawing restoring unit 19.

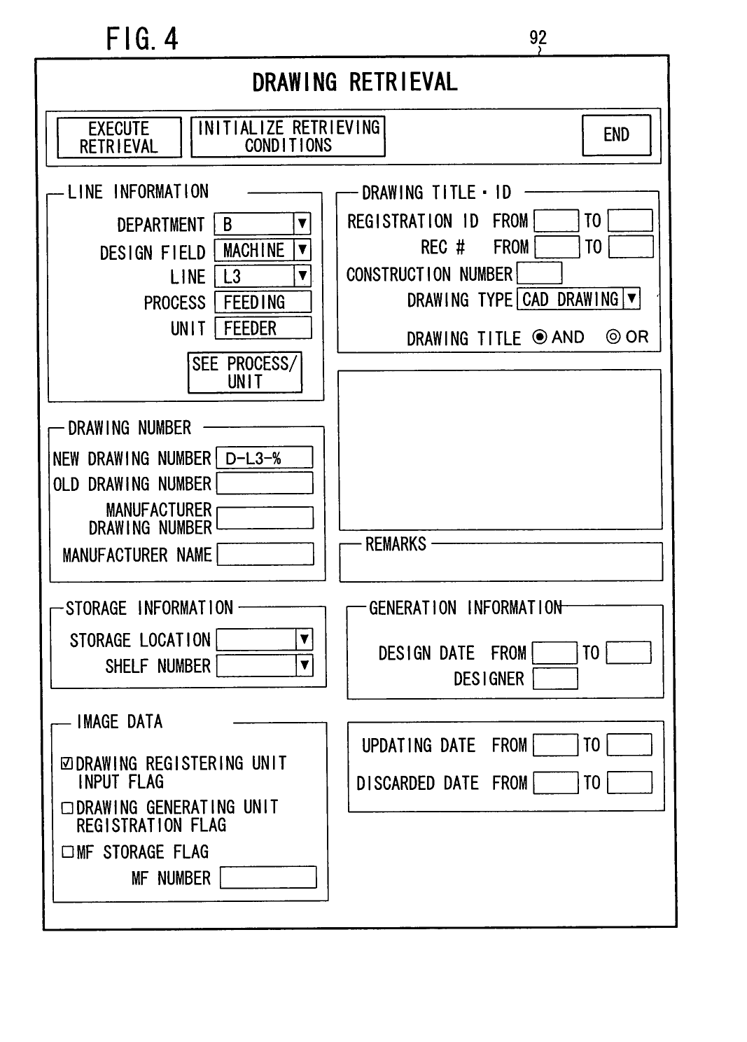

Then, a desired image file is retrieved from the image files stored in the data memory 34 by the drawing retrieving unit 20. Then, viewers are activated in step S4, and the image displaying means 42 displays a retrieval condition input screen 92 shown in FIG. 4.

Using the displayed retrieval condition input screen 92, the operator enters a retrieval condition based on the attribute data that accompanies the desired image data, e.g., department information about a department and a line related to the image data, and a person in charge of the image data, in step S5.

When the operator selects an “EXECUTE RETRIEVAL” button after having entered the retrieval condition, the image file retrieving means 36 retrieves an image file having attribute data that matches the entered retrieval condition from the data memory 34 in step S6. At this time, a plurality of image files may be retrieved as matching the retrieval condition.

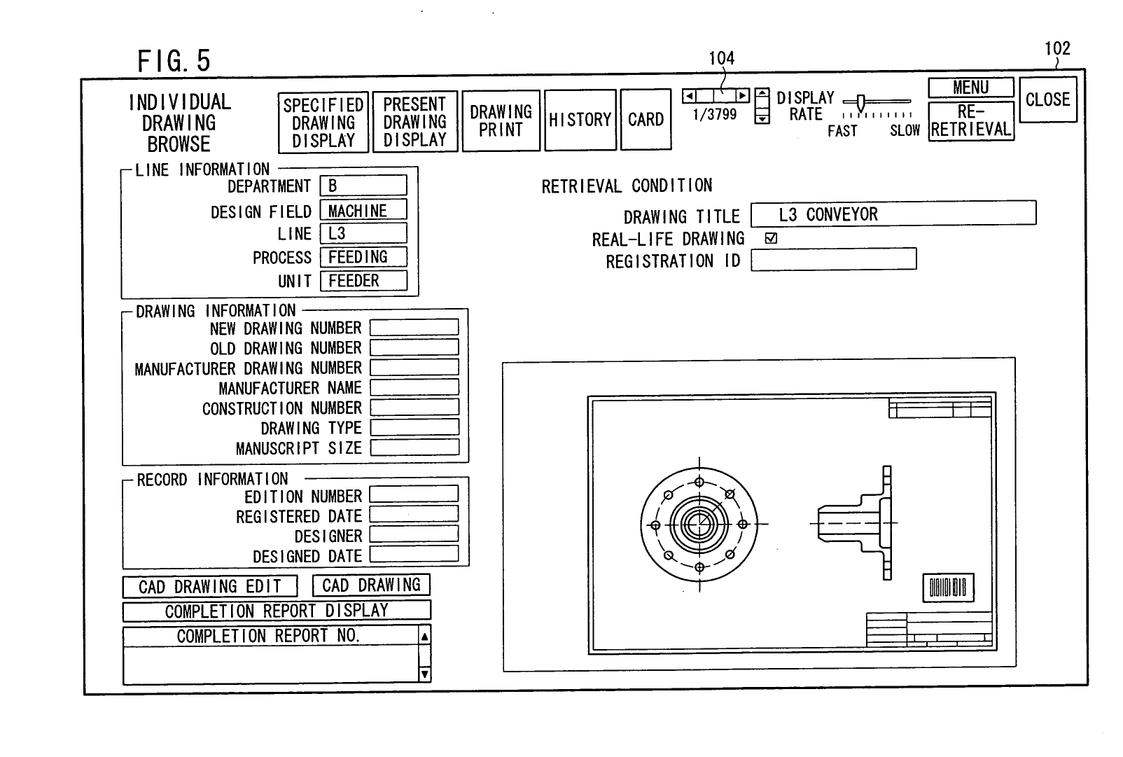

Then, the extension confirming means 38 confirms the extension of the first image file that has been retrieved, in step S7. Then, the viewer selecting means 40 selects a viewer which is capable of displaying image data of an image file format that is specified by the confirmed extension in steps S8, S9. The image displaying means 42 displays, using the selected viewer, the image data and attribute data of the retrieved first image file on an individual drawing browsing screen 102 shown in FIG. 5 in step S10.

At this time, the drawing retrieving unit 20 activates, in advance, a plurality of viewers corresponding to a plurality of different image file formats. The drawing retrieving unit 20 performs a switching process for setting those viewers which do not correspond to the image file format of the retrieved first image file to a non-display mode and setting the viewer which corresponds to the image file format of the retrieved first image file to a display mode.

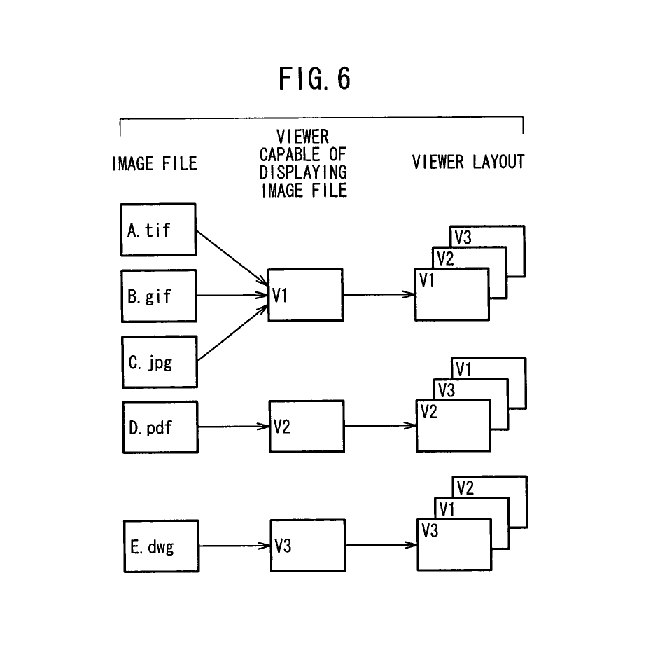

For example, as shown in FIG. 6, the drawing retrieving unit 20 activates a viewer V1 which is capable of displaying image files having extensions tif, gif, jpg, a viewer V2 which is capable of displaying image files having an extension pdf, and a viewer V3 which is capable of displaying image files having an extension dwg. The drawing retrieving unit 20 then performs the switching process to place one of the viewers V1 through V3 which corresponds to the extension of the first retrieved image file, in the foremost layer on a display memory, thereby displaying an image in the image file format of the first retrieved image file.

If a plurality of image files having attribute data matching the retrieval condition are retrieved and the first displayed image data is not the desired image data in step S11, then the operator operates a scroll bar 104 on the individual drawing browsing screen 102 shown in FIG. 5 to display next image data on the individual drawing browsing screen 102.

Specifically, the extension of the image file is confirmed in step S7, and it is determined whether the viewer set to the display mode in the foremost layer is capable of displaying the image file or not in step S8. If the viewer is incapable of displaying the image file, then the drawing retrieving unit 20 repeats the switching process to switch to a next viewer in step S9 until a corresponding viewer is selected to display the image data on the individual drawing browsing screen 102.

Of the viewers stored in the display memory, those viewers which do not correspond to the image file format of the desired image data are set to the non-display mode, and the viewer which corresponds to the image file format of the desired image data is set to the display mode to display the image data. Therefore, the desired image data can efficiently be extracted from the image data that are successively displayed regardless of their image file formats without the need for the operator to be concerned about switching between the viewers.

Although a certain preferred embodiment of the present invention has been shown and described in detail, it should be understood that various changes and modifications may be made therein without departing from the scope of the appended claims.

What is claimed is:

1. An apparatus for displaying an image using a viewer corresponding to an image file format thereof, comprising:
confirming means for confirming an image file format of image data to be displayed;
selecting means for selecting a viewer corresponding to the confirmed image file format from a plurality of viewers which correspond to a plurality of different image file formats, respectively; and
display means for displaying the image data according to the selected viewer.

2. An apparatus according to claim 1, wherein said display means sets other viewers than said viewer corresponding to said confirmed image file format to a non-display mode.

3. An apparatus according to claim 1, wherein said confirming means specifies image file formats based on extensions of image files thereof.

4. An apparatus according to claim 1, further comprising:
storage means for storing image data; and
retrieving means for retrieving image data from said storage means according to a retrieval condition;
wherein said confirming means confirms the image file format of the image data retrieved by said retrieving means.

5. A method of displaying an image using a viewer corresponding to an image file format thereof, comprising the steps of:
activating a plurality of viewers which correspond to a plurality of different image file formats, respectively;
confirming an image file format of image data to be displayed;
selecting a viewer corresponding to the confirmed image file format from the activated viewers; and
displaying the image data according to the selected viewer.

6. A method according to claim 5, further comprising the steps of:
setting the viewer corresponding to the confirmed image file format to a display mode to display the image data; and
setting other viewers than said viewer corresponding to said confirmed image file format to a non-display mode.

7. A method according to claim 5, wherein image file formats are specified based on extensions of image files thereof.

8. A method according to claim 5, wherein desired image data is retrieved according to a retrieval condition, and the image file format of the retrieved image data is confirmed.
